(19) United States
(12) Patent Application Publication
(10) Pub. No.: US 2014/0205301 A1
(43) Pub. Date: Jul. 24, 2014

(54) MODULATION UNIT

(71) Applicant: Kabushiki Kaisha Toshiba, Minato-ku (JP)

(72) Inventors: Bernd Matthias FROHLICH, Cambridge (GB); Zhiliang YUAN, Cambridge (GB); Andrew James SHIELDS, Cambridge (GB)

(73) Assignee: Kabushiki Kaisha Toshiba, Minato-ku (JP)

(21) Appl. No.: 14/163,508

(22) Filed: Jan. 24, 2014

(30) Foreign Application Priority Data
Jan. 24, 2013 (GB) 1301266.1

(51) Int. Cl. H04B 10/70

(52) U.S. Cl. CPC H04B 10/70
USPC 398/152

(57) ABSTRACT

A modulation unit for a quantum communication system, wherein said modulation unit comprises an optical component configured to cause a delay between photons with different polarisation modes and a phase modulator, the optical component comprising a birefringent optical material, wherein the birefringent optical material supports the transmission of photons with a first polarisation mode and a second polarisation mode, wherein the optical path length for photons propagating with the first polarisation mode is different to the optical path length of photons propagating with the second polarisation mode, photons with the first polarisation mode having an orthogonal polarisation to those with the second polarisation mode, the phase modulator being configured to apply a further phase difference between photons with the first and second polarisation mode which pass through said modulation unit.

### FIELD

Embodiments described herein relate generally to modulation units for quantum communication systems and quantum communication methods.

### BACKGROUND

In a quantum communication system, information is sent between a transmitter and a receiver by encoded single quanta, such as single photons. Each photon carries one bit of information encoded upon a property of the photon, such as its polarisation, phase or energy/time. The photon may even carry more than one bit of information, for example, by using properties such as angular momentum.

Quantum key distribution (QKD) is a technique which results in the sharing of cryptographic keys between two parties; a transmitter, often referred to as “Alice”, and a receiver, often referred to as “Bob”. The attraction of this technique is that it provides a test of whether any part of the key can be known to an unauthorised eavesdropper, often referred to as “Eve”. In many forms of quantum key distribution, Alice and Bob use two or more non-orthogonal bases in which to encode the bit values. The laws of quantum mechanics dictate that measurement of the photons by Eve without prior knowledge of the encoding basis of each causes an unavoidable change to the state of some of the photons. These changes to the states of the photons will cause errors in the bit values sent between Alice and Bob. By comparing a part of their common bit string, Alice and Bob can thus determine if Eve has gained information.

QKD systems which use phase-encoding can employ asymmetric Mach-Zehnder interferometers at both the transmitter and the receiver to encode and decode the phase information. The Mach-Zehnder interferometer can contain a beam splitter, which divides light pulses into two fibres. The fibres then recombine on a second beam splitter. The separate fibres are labelled the short arm and the long arm. A phase modulator can be installed on one arm of the interferometer, or after the interferometer. The phase modulator installed in the transmitter encodes the phase information.

The path length difference between the short arm and long arm means that a light pulse travelling the long arm will exit the interferometer at a time t _delay after a light pulse travelling the short arm. The path length difference for the interferometer at the transmitter and the path length difference for the interferometer at the receiver should match, meaning that the delay times for the interferometers are equal to within the signal laser coherence time.

### BRIEF DESCRIPTION OF THE FIGURES

Embodiments will now be described with reference to the following figures:

FIG. 1(a) is a schematic of a birefringent optical fibre which can be used in a differential group delay line for use in a modulator in accordance with an embodiment of the present invention, FIG. 1(b) is a schematic of a birefringent crystal which can be used in a differential group delay line for use in a modulator in accordance with an embodiment of the present invention, FIG. 1(c) is a schematic of a birefringent photonic crystal which can be used in a differential group delay line for use in a modulator in accordance with an embodiment of the present invention, and FIG. 1(d) is a schematic of a directing system which can be used in a differential group delay line for use in a modulator in accordance with an embodiment of the present invention;

FIG. 2(a) is a schematic of a quantum transmitter in accordance with an embodiment of the present invention, FIG. 2(b) is a schematic of a rotated fibre splice, FIG. 2(c) is a schematic of a polarisation controller and FIG. 2(d) is a schematic of a half-waveplate;

FIG. 3(a) is a schematic of a quantum transmitter in accordance with a further embodiment of the present invention; FIG. 3(b) illustrates the feasibility of such a transmitter;

FIG. 4 is a schematic of a quantum transmitter in accordance with a further embodiment of the present invention, where a phase modulator is positioned prior to a differential group delay line;

FIG. 5 is a schematic of a quantum transmitter, in accordance with a further embodiment of the present invention, where several sources of light pulses are employed and the phase modulation applied depends on a path taken by the photons through the transmitter;

FIG. 6(a) is a schematic of a quantum receiver, in accordance with a further embodiment of the present invention; FIG. 6(b) illustrates the electric field vectors before and after the polarization modes are mixed;

FIG. 7 is a schematic of a quantum receiver, in accordance with a further embodiment of the present invention, where a phase modulator is positioned subsequent a differential group delay line;

FIG. 8 is a schematic of a quantum receiver, in accordance with a further embodiment of the present invention, wherein several detectors are employed and the phase modulation applied depends on a path taken by the photons through the receiver;

FIG. 9 is a schematic of a quantum communication system, in accordance with a further embodiment of the present invention, where a differential group delay line is employed in the transmitter;

FIG. 10 is a schematic of a quantum communication system, in accordance with a further embodiment of the present invention, where a differential group delay line is employed in the receiver;

FIG. 11 is a schematic of a quantum communication system in accordance with a further embodiment of the present invention, where differential group delay lines are employed in both the transmitter and receiver;

FIG. 12 is a schematic of the quantum communication system of FIG. 9, adapted such that there is active stabilization on the receiver side; and

FIG. 13 is a schematic of the quantum communication system of FIG. 9, adapted such that there is active stabilization on the transmitter side.

### DETAILED DESCRIPTION

In an embodiment, a modulation unit for a quantum communication system is provided, wherein said modulation unit comprises an optical component configured to cause a delay between photons with different polarisation modes and a phase modulator, the optical component comprising a birefringent optical material, wherein the birefringent optical material supports the transmission of photons with a first polarisation mode and a second polarisation mode, wherein the optical path length for photons propagating with the first polarisation mode is different to the optical path length of photons propagating with the second polarisation mode, photons with the first polarisation mode having an orthogonal polarisation to those with the second polarisation mode, the phase modulator being configured to apply a further phase difference between photons with the first and second polarisation mode which pass through said phase modulation unit.

The first mode and the second mode may propagate through said birefringent optical material in the same direction.

The birefringent optical material operates as a differential group delay (DGD). There are many different possibilities for implementing the birefringent optical material. For example said birefringent optical material may be selected from a birefringent optical fibre, a birefringent crystal and a birefringent photonic crystal.

All single mode fibres may provide some degree of birefringence dependent on stresses in the fibre. However, in a standard single mode fibre, any birefringence would not be uniform in the fibre. Further, for a fibre to be considered to have useable birefringent properties, the fibre would be expected to exhibit a difference in refractive index of at least 10⁻⁵ between the two polarisation modes.

In a further embodiment, a directing unit is provided which is configured to direct said first and second polarisation modes a plurality of times through said birefringent optical material.

Two polarisation modes passing through the birefringent optical material will experience different optical paths. In some embodiments the modulator will receive photons which already exhibit two polarisation modes. However, in some embodiments, the modulations unit will need to produce the two polarisation modes. In such embodiments, the modulation unit may further comprise a polarisation splitting device configured to separate a light pulse into at least two polarisations. The polarisation splitting device may be selected from many possible implementations, for example: two fibres spliced together with the slow axis of one fibre being rotated with respect to the other, a polarisation controller and a half wave plate.

The unit of providing a phase modulator in combination with a birefringent optical material allows an interferometer to be realised which can be used for quantum communication. For example, in an embodiment, a sending unit for a communication system is provided, wherein said sending unit comprises the modulator as described above, the unit being configured to encode information on weak light pulses using said phase modulator.

The phase modulator is positioned such that photons pass through said phase modulator, the unit may further comprise a controller configured to control the modulation applied by said phase modulator. The phase modulator may be provided before or after the birefringent optical material in the path of the photons. Photons which have followed the faster optical path through the birefringent optical material will exit the birefringent material before the photons that have followed the slower optical path. If the phase modulator is provided after the birefringent optical material, the phase modulator can be controlled to identify one of the pulses based on the time it exits the birefringent optical material and apply a phase shift to that pulse. If the phase modulator is provided before the birefringent material, the birefringence of the phase modulator itself can be used to treat photons with the two polarisation modes differently. It should be noted that if the phase modulator is provided after the birefringent optical material, it can also use its own birefringence to treat the photons with different polarisations differently.

The phase modulation may also be provided by passive means, for example, the phase modulator may comprise a plurality of fixed phase elements each configured to apply a different fixed phase difference, a switch configured to select each of the said components and a controller configured to operate said switch. The elements may comprise a light source which is combined with a unit to provide the fixed phase difference such that photons can be emitted with a set phase difference. In one visualisation, the plurality of fixed phase elements are provided on different arms and the switch selects which arm is used to provide photons.

As noted above, the sending unit may comprise a photon source, said photon source being configured to emit light pulses comprising 10 or fewer photons.

In a further embodiment, a receiving unit for a communication system is provided, the receiving unit comprising a detector, an optical component as described above and a phase modulator, the unit being configured to decode information from weak light pulses using said phase modulator.

In an embodiment, the phase modulator is positioned such that photons pass through said phase modulator, the unit further comprising a controller configured to control the modulation applied by said phase modulator. As the receiving unit will usually be receiving 2 pulses which are separated in time, the timing of the pulses can be used by the phase modulator to shift the phase of one pulse if the photons pass through the phase modulator before entering the birefringent material. Also, the birefringence of the phase modulator itself can be used to selectively apply modulation to the 2 polarisations.

In an embodiment, the phase modulator comprises a plurality of elements each configured to apply a fixed phase difference and each located in a different path such that the phase difference applied depends on the path taken by the photons. In a further embodiment, a switch is provided which is configured to select a path and a controller is provided which is configured to operate said switch. In other embodiments, the path may be selected in a passive manner. Each component may comprise a detector.

In a further embodiment, a quantum communication system is provided comprising a sending unit and a receiving unit, the sending unit comprising an interferometer and the receiving unit comprising an interferometer, wherein the interferometers comprise a first and second optical path with a difference in length between the first and second optical paths, and at least one of the interferometers comprises a birefringent optical material wherein the birefringent optical material supports the transmission of photons with a first polarisation mode and a second polarisation mode, wherein the optical path length for photons propagating with the first polarisation mode is different to the optical path length of photons propagating with the second polarisation mode.

In an embodiment, the delay caused by the interferometer in the sending unit between the first and second optical paths is reversed to the delay caused by the interferometer in the receiving unit such that a photon pulse which is separated by the first interferometer recombines when exiting the second interferometer. This allows the delay introduced by the receiving unit interferometer to cancel any delay introduced by the interferometer in the sending unit and also any other components in the system.

In some embodiments, both the interferometer of the sending unit and the receiving unit comprise a birefringent optical material wherein the birefringent optical material supports the transmission of photons with a first polarisation mode and a second polarisation mode, wherein the optical path length for photons propagating with the first polarisation mode is different to the optical path length of photons propagating with the second polarisation mode.

In a further embodiment, a method of quantum communication is provided comprising: sending encoded photons from a sending unit to a receiving unit wherein said photons are encoded using phase in the sending unit and decoded in the receiving unit and wherein the sending unit comprises an interferometer and a phase modulator to perform the encoding and the receiving unit comprises a phase modulator and an interferometer to perform the decoding, and wherein at least one of the interferometers comprises a birefringent optical material wherein the birefringent optical material supports the transmission of photons with a first polarisation mode and a second polarisation mode, wherein the optical path length for photons propagating with the first polarisation mode is different to the optical path length of photons propagating with the second polarisation mode.

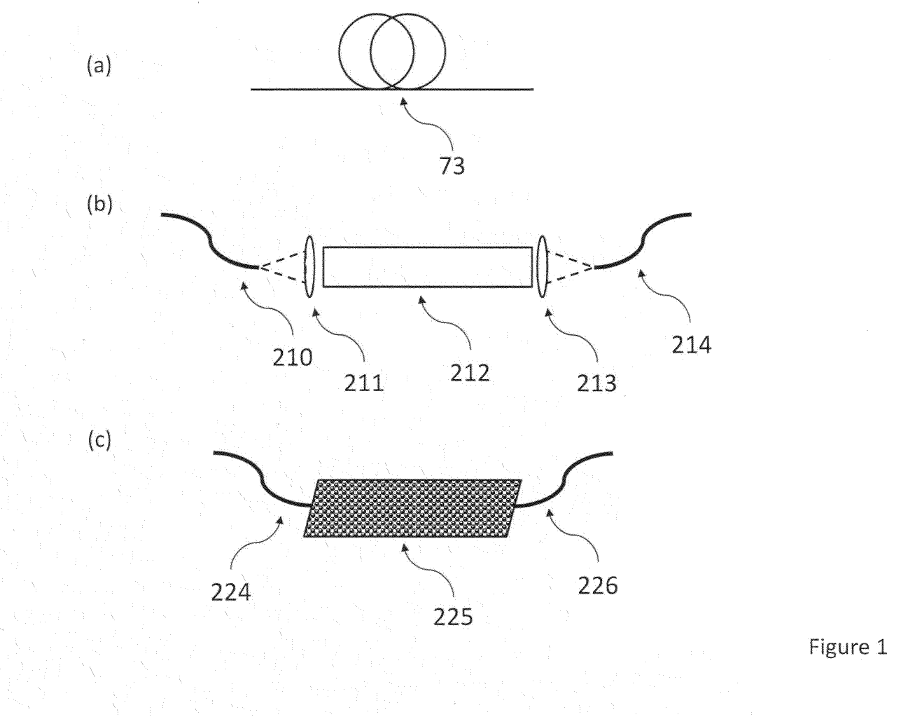

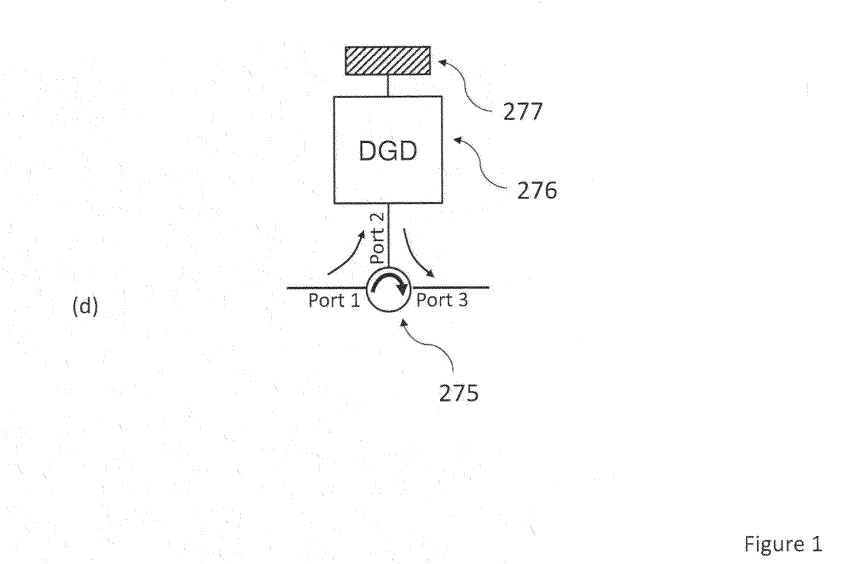

FIG. 1(a) is a schematic of a birefringent optical fibre 73 which may be used in a modulation unit in accordance with an embodiment of the present invention. The component can support two polarisation modes. The polarisation modes have orthogonal polarisations to each other and different optical path lengths. The different optical path lengths are due to the differing refractive indices experienced by the two different polarisations. The different optical path length can be controlled by controlling the length of the fibre and therefore it is possible to control the temporal separation of two pulses entering the fibre. Thus, if a multiphoton pulse of light enters birefringent fibre 73 and some of the photons in the pulse have the first polarisation mode and others have the second polarisation mode, two pulses will exit the birefringent fibre.

Similarly, two pulses one with photons of the first polarisation mode and the other pulse comprising photons with the second polarisation mode will exit the birefringent fibre as a single pulse if the delay introduced by the birefringent fibre 73 is matched to the temporal separation of the two pulses on entry into the birefringent fibre.

FIG. 1(a) has shown the birefringent optical material as a birefringent fibre. However, other variations are possible. See for example, FIG. 1(b). Here, a birefringent crystal 212 is used. The birefringent crystal 212 works in a similar way to the birefringent fibre 73 of FIG. 1(a) and it serves to delay photons with one polarisation mode with respect to photons with a different polarisation mode. Light from a polarisation-maintaining fibre 210 is collimated with a lens 211 which directs the light into birefringent crystal 212. At the output of the birefringent crystal, the light is coupled back into a polarisation-maintaining fibre 214 by coupling lens 213.

Another alternative to a birefringent optical fibre is provided by birefringent photonic crystal 225. In FIG. 1(c), the birefringent photonic crystal is provided on a chip. Light from a polarisation-maintaining fibre 224 is coupled into the birefringent photonic crystal waveguide on a chip 225. This can be done for example by directly bonding the fibre to the chip. At the output of the photonic crystal waveguide the light is coupled back into a polarisation-maintaining fibre 226.

FIG. 1(d) shows a further example which can be implemented using any of the above birefringent optical materials, here the photons pass through the differential group delay line 276 which comprises birefringent material twice by means of an optical circulator 275 and a mirror 277.

Photons entering port 1 of the optical circulator 275 exit the circulator through port 2. The photons then pass into the differential group delay line 276 which introduces a time delay Δt/2 between the two orthogonal polarisation modes. The photons are reflected on mirror 277 which does not change the polarisation of the incoming photons. A standard component to reflect light inside a fibre is a Faraday mirror, which does rotate the polarisation of the incoming light by 90°. Therefore, Faraday mirrors are not used as component 277 unless further components are provided to correct for the rotation. Instead, in an embodiment, a simple mirror is used which does not rotate the polarisation of the photons. The photons then pass differential group delay line 276 a second time leading to a total time delay of Δt between the two orthogonal polarisation modes. They enter optical circulator 275 through port 2 and exit the circulator through port 3.

Sending the photons twice through the optical birefringent material has the advantage of introducing twice the differential group delay between the two orthogonal polarisation modes compared to the single pass version. Therefore only half as much optical birefringent material has to be used to generate the same differential group delay. Optical circulator 275 is a polarisation-maintaining optical circulator with polarisation-maintaining fibre connected to all ports.

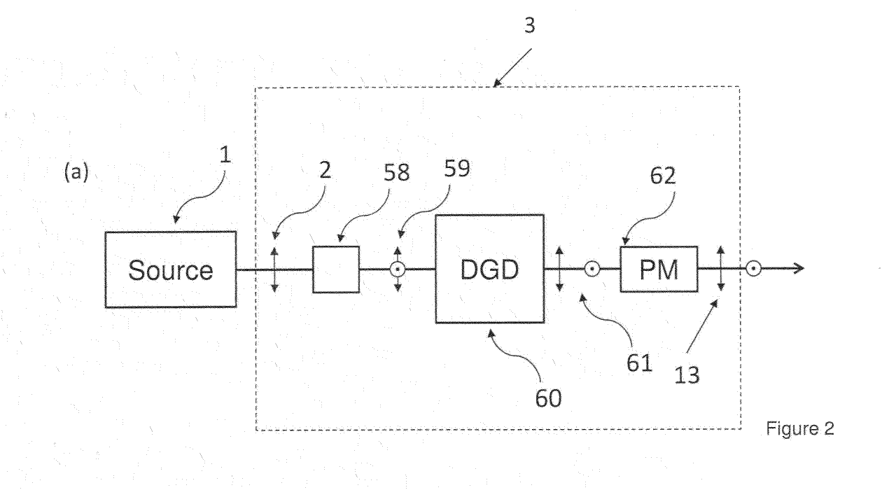

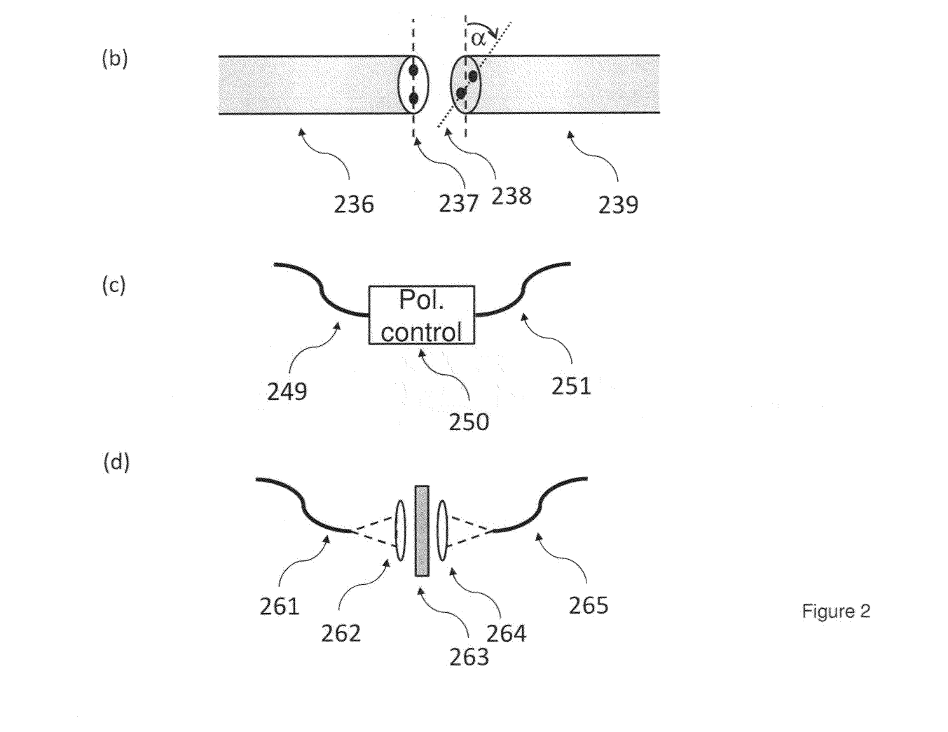

FIG. 2 is a schematic of a quantum transmitter comprising a modulator in accordance with an embodiment of the present invention.

The transmitter comprises a source of photons 1 and a modulator 3. The output of the source 1 is directed into a polarisation splitting device 58 in the modulator 3. The output of the polarisation splitting device 58 is then directed into birefringent material 60 which serves as a differential group delay (DGD) line where the optical path length experienced by photons passing through the DGD is dependent on the polarisation of the photons. The output of the differential group delay line 60 is directed into phase modulator 62 and out of the transmitter.

The light source 1 may comprise a Distributed Feedback Laser (DFB). In some embodiments, the source 1 will also comprise an attenuator configured to attenuate the intensity of the output of the laser. In further embodiments, polarisers may be provided to modulate the polarisation of the outputted photons. Other embodiments may use stronger light pulses or a deterministic single photon source. Even further embodiments may use an entangled-photon source. The light source 1 is connected to the polarising splitting device 58. The light source and polarising splitting device 58 may be connected by a polarisation maintaining fibre.

In further embodiments the source 1 will also comprise an intensity modulator configured to change the intensity of each individual light pulse emitted from the source. Such an intensity modulator may be configured to realise a decoy-state QKD protocol where photon pulses of different intensities are sent which allow the sender and receiver to determine the presence of an eavesdropper by measuring the number of pulses which have been safely received with the different intensities. In some embodiments, the source comprises more than one intensity modulator.

In the embodiment of FIG. 2(a), the light source 1 generates polarized pulses 2 which are output to polarisation splitting device 58. Polarising splitting device 58 is configured to provide pulses of photons to the DGD 60 with a polarisation selected from 2 orthogonal polarisations. Where a single photon passes through the splitter it has a probability of being in one of the 2 possible polarisations, where a classical multiphoton pulse passes through the polarisation splitter, the multiphoton pulse is divided into a pulse with two polarisations. The polarisation splitting device 58 may be provided for example by two polarization-maintaining fibers spliced together, with the slow axis of the fibers being deliberately rotated by a chosen angle. Such an arrangement is shown in FIG. 2(b). Here, two black dots indicate the stress rods which cause the birefringence in PANDA style polarisation-maintaining fibres 236 & 239. The slow axis is indicated by the dashed line 237 for the first fibre 236 and by the dotted line 238 for the second fibre 239. The additional dashed line at the second fibre and angle alpha indicate that the two slow axes are rotated with respect to each other by angle alpha.

A further example of a polarisation splitter is shown in FIG. 2(c). Here, a single-mode input fibre 249 and polarisation controller 250 are used. The photons enter first single-mode fibre 249 and polarisation controller 250 before entering the second polarisation-maintaining fibre 251. Using polarisation controller (250) the splitting/mixing ratio into the two orthogonal polarisation modes can be varied.

A yet further example of the polarisation splitter is shown in FIG. 2(d). Here, light from a first polarisation-maintaining fibre 261 is collimated using lens 262, sent through half-waveplate 263, and then re-coupled into second polarisation-maintaining fibre 265 by coupling lens 264. The half-waveplate 263 allows rotating the polarisation of the incoming light by an arbitrary angle before it is coupled back into fibre 265. This again allows varying the splitting/mixing ratio of the two orthogonal polarisation modes.

In an embodiment, a variable splitting ratio is allowed by coupling light from one polarization-maintaining fiber into a second polarization-maintaining fiber which can be rotated with respect to the first fiber. The polarization splitting device can be omitted if the source already emits light in two polarization modes with the desired intensity ratio and a fixed phase difference.

The split light pulses 59 enter the DGD line 60 introducing a DGD between the two orthogonal polarization modes, which propagate along the DGD line 60 in the same direction.

The differential group delay line 60, comprises an birefringent material which supports two polarisation modes with a different optical path length for each of the two polarisation modes. The two polarisation modes have orthogonal polarisations to each other. For the avoidance of doubt, the optical path length is the product of the geometric path length and the index of refraction. Therefore, although the geometric path length for both modes is equal, the index of refraction for each of the two modes will be different and thus the optical path length experienced by each of the two modes will be different. In this way, a DGD line 60 makes use of birefringence to delay one polarisation mode with respect to the other and hence photons with one polarisation can be delayed with respect to the other. A DGD line 60 is, for example, a polarization-maintaining fiber. Other options include photonic crystals, photonic crystal fibres, and birefringent crystals.

After propagation through the DGD line 60, one of the incoming light pulses is delayed with respect to the other 61. These pulses enter a phase modulator 62 which can introduce a phase shift between the early and late pulse. The phase modulation between the early and late pulse can be applied in one of two ways. In one embodiment, different voltages can be applied to the phase modulator 62 during the transit of the early and late pulse so as to impart different phase delays. Alternatively the same voltage can be applied during the transit of both pulses. Because of the birefringence of the phase modulator 62 this will also impart a different phase delay to the two orthogonally polarized pulses. The phase modulator can also be used for example for active stabilization of the phase difference as described later. A typical material used to fabricate phase modulators is LiNbO₃. In LiNbO₃ the phase delay of one polarisation mode is three times greater than for the other orthogonal mode for the same applied voltage.

The DGD may terminate directly at the phase modulator or may terminate in free space or even in a single mode fibre which will allow the two polarisation modes to continue but without the difference in the refractive index experienced by the 2 modes.

In this embodiment, the photons may then exit the transmitter via either free space or a fibre such as a single mode fibre which will allow propagation of the 2 modes, but without introducing a significant optical path difference between the 2 modes.

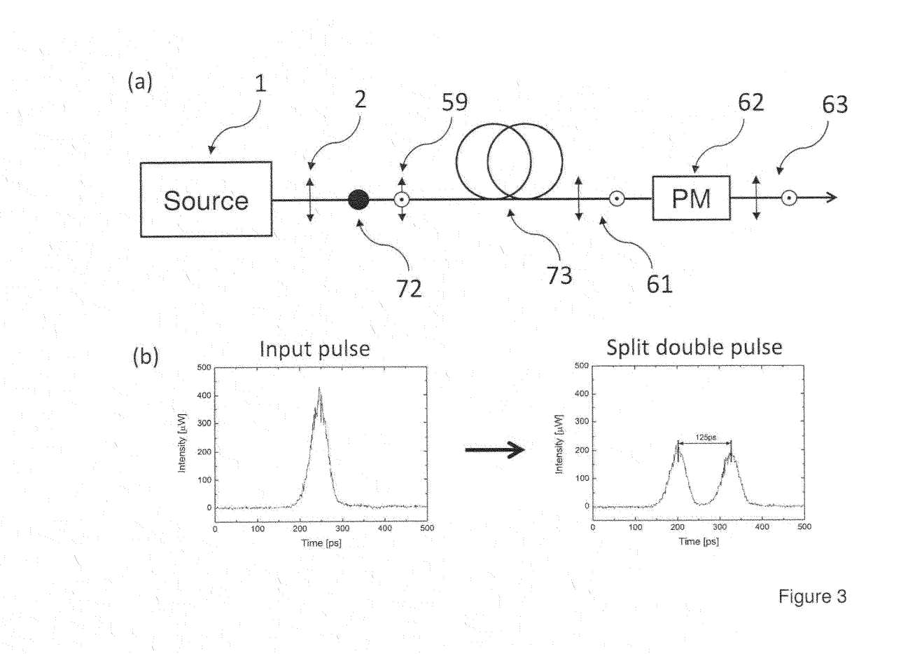

FIG. 3a is a schematic of a quantum transmitter, in accordance with a further embodiment of the present invention, where the polarization splitting device is made of a rotated splice of two polarization-maintaining fibers 72. The transmitter of FIG. 3a is similar to the transmitter of FIG. 2 and to avoid any unnecessary repetition, like reference numerals will be used to denote like features. The polarising splitting device comprises the slow axis of one fiber rotated with respect to the slow axis of the second fiber, therefore coupling light from one polarization mode of the first fiber into both polarization modes of the second fiber. The splitting ratio can be set by choosing the rotation angle. An angle of 45 degrees for example leads to an equal splitting ratio of 1:1. In an embodiment, the splitting ratio is chosen so as to achieve maximum visibility after the receiver interferometer.

The DGD is introduced in a length of polarization maintaining fiber 73. Therefore in this embodiment, the differential group delay line, is a length of polarization maintaining fibre 73. Polarization-maintaining fiber supports light propagation in two orthogonal polarization modes, along the slow axis and the fast axis. Slow and fast axes have a different index of refraction nₛ and n_{f}, with nₛ being larger than n_{f}. This difference is usually expressed in terms of the beat length Lₚ=λ/(nₛ−n_{f}), where A is the wavelength of the light. Typical values are 3-5 mm. A length of 100 m of polarization-maintaining fiber leads to a delay of 155 ps between mode one and two at a wavelength of 1550 nm and a beat length of 5 mm. A typical delay used in QKD is about 500 ps corresponding to 200-400 m of polarization-maintaining fiber. A precision of 1 ps can be reached fairly easy as this corresponds to an accuracy in the fiber length of 40-80 cm. In contrast, the relative lengths of the two arms of a Mach-Zehnder interferometer are controlled to within 0.2 mm for the same precision of the delay.

The transmitter of FIG. 3(a) comprises a light source 1, which can be one of the light sources described previously. The light source is connected to a rotated fibre splice of two polarisation maintaining fibres 72. The rotated splice comprises two lengths of polarisation maintaining fibre, which are spliced together. The fibres are aligned such that the fast and slow axes of the first fibre are rotated with respect to the fast and slow axes of the second fibre. The angle of rotation will determine the intensity ratio between the two polarisation modes. For example, if a light pulse has a polarisation which is aligned to be parallel with the slow axis of the first polarisation maintaining fibre, and the angle of rotation is 45 degrees, the pulse will be split into a first polarisation mode where the polarisation is parallel to the slow axis of the second polarisation maintaining fibre, and a second polarisation mode where the polarisation is parallel to the fast axis in the second polarisation maintaining fibre, with a 1:1 intensity ratio.

The rotated fibre splice 72 is connected to a length of polarisation maintaining fibre 73 which is a differential group delay line. The index of refraction for the polarisation maintaining fibre is different for polarisation aligned with the fast and slow axis. Therefore a light pulse with polarisation aligned along the fast axis of the fibre will experience a different optical path length to a light pulse with polarisation aligned along the slow axis.

The length of polarisation maintaining fibre 73 is connected to a phase modulator 62 which has been described previously.

FIG. 3(b) illustrates the feasibility of a transmitter using a rotated splice and polarization-maintaining fiber. An angle of 45 degrees was used to achieve a 1:1 splitting ratio of the input pulse shown on the left side. After a travelling distance of 96 m in a length of polarization-maintaining fiber the delay between the two polarization modes is 125 ps, as can be seen in the right figure. Both pulses have about equal intensity as expected.

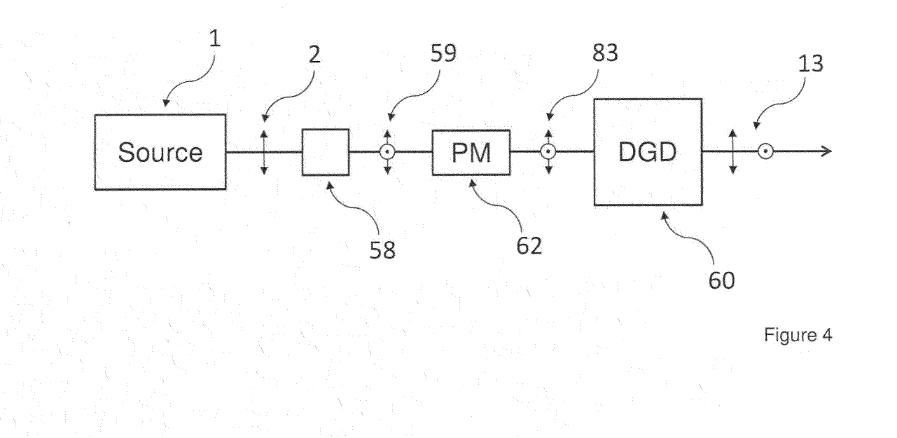

FIG. 4 is a schematic of a quantum transmitter, in accordance with a further embodiment of the present invention, where a phase modulator is positioned prior to the differential group delay line. The transmitter of FIG. 4 is similar to the transmitter of FIG. 2 and to avoid any unnecessary repetition, like reference numerals will be used to denote like features.

In this transmitter, the phase modulator 62 is installed in front of the DGD line 60. Therefore, first the chosen phase difference between the two pulses is introduced 83, and then the pulses are separated in time by the DGD. Because the two orthogonal polarization modes are not yet separated in time, the same voltage is applied in the PM during the transit of these modes. This still leads to a phase difference between them as explained previously since the 2 modes entering the phase modulator have different polarisations and thus the phase modulator can introduce a phase difference between the 2 polarisation modes.

In this embodiment, the light source 1, which can be one of the example light sources described previously with reference to FIG. 2, is connected to the polarisation splitting device 58. The polarisation splitting device 58 may be any of the components described previously with reference to FIGS. 2(a) to 2(d). For example the polarisation splitting device may be a rotated fibre splice. The polarisation splitting device 58 is connected to a phase modulator 62. The polarisation splitting device 58 and the phase modulator 62 may be connected by a polarisation maintaining fibre. The phase modulator 62 is connected to the differential group delay line 60, which can be one of the examples described previously, for example, the differential group delay line 62 may be a length of polarisation maintaining fibre.

Signal pulses emitted from the light source 1 are split into orthogonal polarisation modes with a desired intensity ratio at the polarisation splitting device 58. The signal pulses then travel through the phase modulator 62. A voltage is applied at the phase modulator 62. Due to the birefringence of the phase modulator 62, the phase shift resulting from a given applied voltage is different for each polarisation mode. Therefore the phase modulator 62 encodes information in a phase difference of the two polarisation modes. The signal pulses then propagate through the differential group delay line. The optical path length for the two polarisation modes through the interferometer is different. The output 13 is the same as that of FIG. 2.

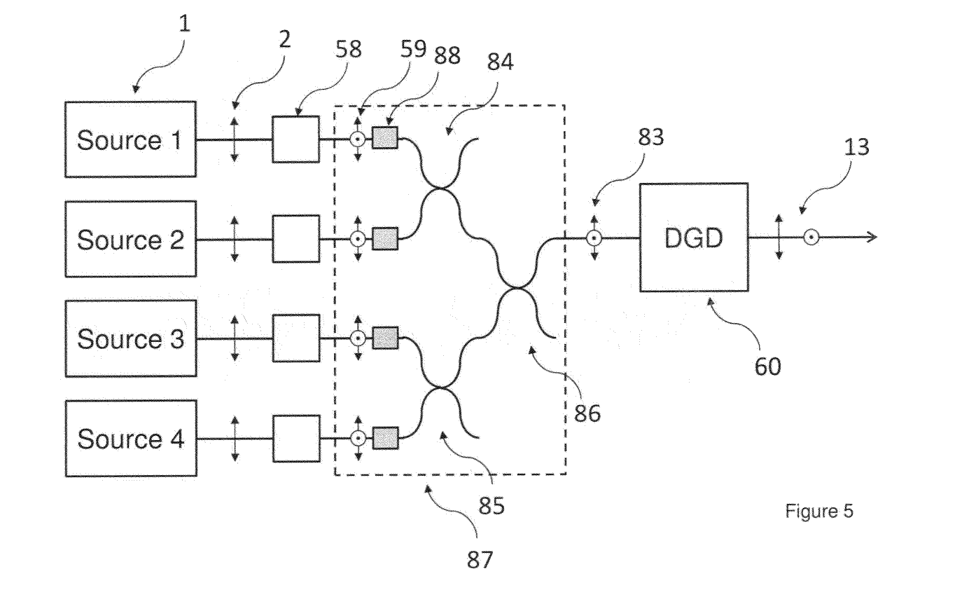

FIG. 5 shows a schematic of a transmitter in which no phase modulator is used in the transmitter. Instead, the transmitter contains several sources 1 and polarization splitting elements 58. The transmitter of FIG. 5 is similar to the transmitter of FIG. 2 and to avoid any unnecessary repetition, like reference numerals will be used to denote like features. In this transmitter, this is demonstrated for four sources 1 and four splitting elements 58 which would be necessary for the BB84 protocol. Each arm generates double pulses 59 with a different chosen phase difference and only one arm emits light at a time.

The double pulses are combined on beam splitters 84 to 86 before a DGD is introduced with the DGD line. Output 13 is again the same as that of FIGS. 2 and 3.

The transmitter shown in FIG. 5 comprises four light sources 1. These light sources 1 are each located on a separate arm. Each light source 1 is connected to a polarisation splitting device 58, which may be one of the polarisation splitting device components described previously. For example the polarisation splitting device 58 may be a rotated fibre splice. After the pulse has passed through the polarisation splitting device, it enters a fixed phase difference element 88. In an embodiment, this is a section of the path which is controlled by a heating element. The heating element allows the phase difference between the 2 polarisation modes exiting the polarisation splitter to be modified.

Each separate arm comprises a light source 1, a polarisation splitting device 58 and a section 88 which is configured to cause a phase difference between the 2 polarisation modes. A first two arms are connected at a beam splitter 84, i.e. the fibre of a first arm and the fibre of a second arm are connected to the inputs of a beam splitter. A second two arms are connected in a similar fashion at beam splitter 85.

The output fibres of the two beam splitters 84 and 85 are combined on a third beam splitter 86. The output of this beam splitter 86 is connected to the differential group delay line 60.

In an embodiment, the combination of the elements 88 and the beam splitters 84 and 86 form a photonic lightwave circuit (PLC) 87. The PLC allows setting the phase difference between the two orthogonal polarisation modes for each of the four possible optical paths precisely and stably. The elements 88 allow the setting of the phase difference for all four paths individually. In an embodiment, the whole chip on which the PLC 87 is formed is temperature stabilised. The representation shown in FIG. 5 is the simplest realisation of a PLC, including only the elements that have to be stable. However, the PLC can be extended more or less arbitrarily. It could also include the polarisation splitting elements 58, the sources 1 or the DGD 60 in form of a photonic crystal waveguide.

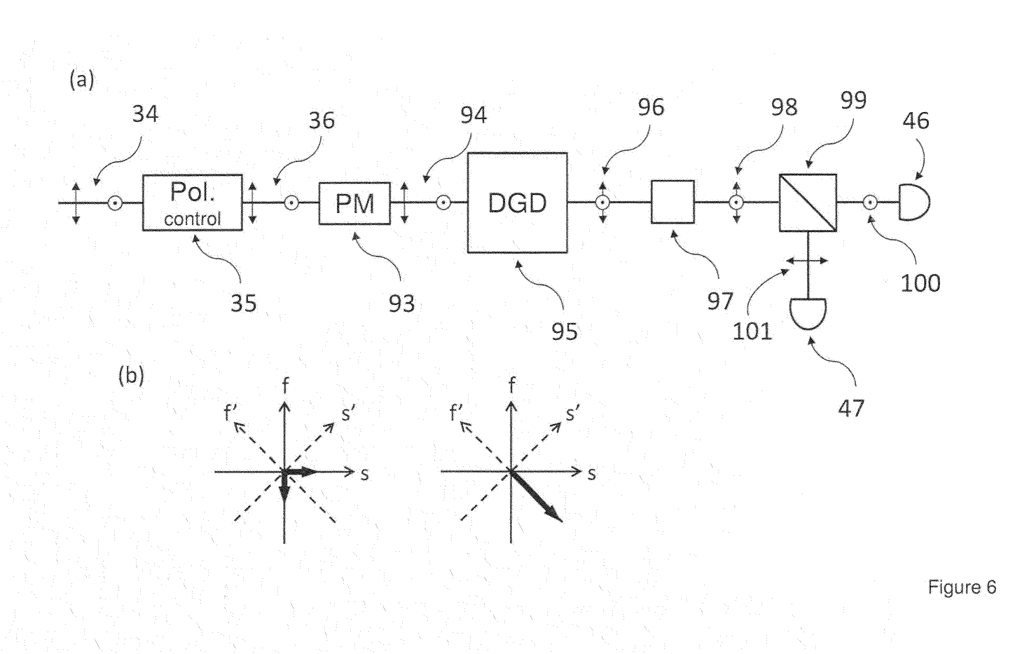

FIG. 6(a) is a schematic of a quantum receiver in accordance with an embodiment of the present invention. In this specific embodiment, the signal input to the receiver is the output from the transmitter described with reference to FIGS. 2 to 5. However, it is possible to use other inputs which will be described later.

To clarify the explanation, the input photons will be described in terms of a mulitphoton pulse which has been split into 2 pulses which are separated in time. However, if the pulse is a single photon pulse, the photon has a probability of being in one of the two pulses.

An incoming coherent multi-photon double light pulse 34 passes through a polarization controller 35 which aligns the polarization of the double pulse with respect to fast and slow axis of the input fiber of the phase modulator 93. The aligned pulse 36 enters the phase modulator which introduces a phase shift between the early and late pulse. The modulated double pulse 94 then enters a DGD line 95 which delays the early pulse in order to coincide in time with the late pulse 96. The DGD introduced by the DGD line therefore needs to match the delay introduced by the Quantum Transmitter precisely. The DGD line allows this delay to be achieved with high accuracy.

The double pulse 96 then enters a polarization mixing device 97 which may be identical to the polarization splitting device 58 of FIG. 2 with a 1:1 splitting ratio. The polarization mixing device can be omitted if the input fiber of the polarizing beam splitter 99 is rotated by 45 degrees with respect to the main axes of the beam splitter. When the polarization modes are mixed they interfere constructively or destructively leading to an intensity in the two mixed output modes which is determined by the phase difference of the incoming pulses. The two mixed polarization modes 98 are separated with a polarizing beam splitter 99 sending one polarization mode 100 to one detector 46 and the other polarization mode 101 to a second detector 47.

The input fibre of the receiver connects to the polarisation controller 35. The polarisation controller will align the polarisation of a pulse with the input fibre of the phase modulator 93. The polarisation controller 35 functions to rotate the polarisation to align with the axis of the polarisation modulator and DGD 95. When the pulses were transmitted to the receiver, there is a chance that the polarisation rotates in the transmission medium which may be a single mode fibre of the like. The polarisation controller corrects for any unwanted rotation of the polarisation en-route to the receiver.

The phase modulator may be such as has been described previously. The phase modulator applies a phase shift to one or both polarisation modes. The phase shift applied to each polarisation mode may be different, either due to the application of a different voltage for each mode, or due to the birefringence of the phase modulator. The modulator 93 may be configured to selectively apply modulation to one of the pulses based on the timing of the pulse or the polarisation of the pulse.

The output fibre of the phase modulator 93 is connected to the differential group delay line 95. The differential group delay line 95 comprises a birefringent material, for example, of the type described with reference to FIGS. 1(a) to 1(d), The differential group delay line supports two polarisation modes with a different optical path for each mode.

The differential group delay line is aligned with the output of the phase modulator 93 such that the polarisation of the first light pulse of the double light pulse is aligned with the slow optical axis of the DGD and the polarisation of the second light pulse is aligned with the fast axis. The DGD is configured such that the length of the two optical paths is set such that the pulses exit the DGD at the same time.

The output of the DGD line 95 is connected to a polarisation mixing device 97.

The output of the polarisation mixing device 97 is connected to the input of a polarizing beam splitter 99. One output of the polarizing beam splitter is connected to a first detector 47, the second output is connected to a second detector, 46.

FIG. 6(b) illustrates the mixing of the polarization modes. The left figure illustrates the electric field vectors of a double pulse before the polarization modes are mixed. The initial polarization axes s and f have an angle of 45 degrees with respect to the mixed polarization axes s′ and f′. The light in modes s and f is projected on these new axes in the polarization mixing device. The result is shown in the right figure. All light is now in polarization mode f′, as the components projected into mode f′ interfere constructively, whereas the components projected into mode s′ interfere destructively.

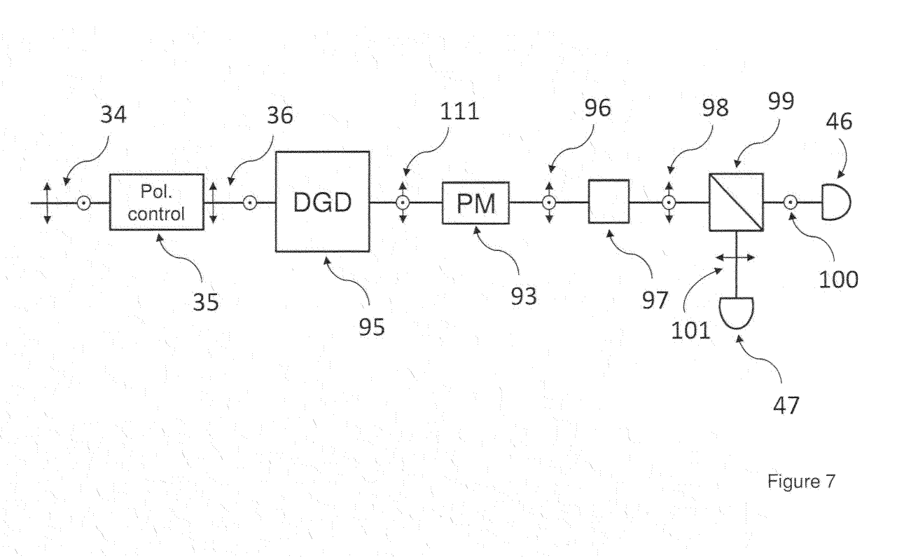

FIG. 7 shows a receiver where the phase modulator 93 is installed after the DGD line 95. Therefore, first the two incoming coherent pulses are overlapped in time 111 and then a phase difference is introduced 94 by the phase modulator 93. The system of FIG. 7 is similar to the system of FIG. 6 and to avoid any unnecessary repetition, like reference numerals are used to denote like features.

The input fibre of the receiver connects to the polarisation controller 35 which has been described previously. The output of the polarisation controller 35 connects to the differential group delay line 95. The optical axes of the components in the receiver are therefore aligned as described in relation to FIG. 6.

The DGD 95 is configured such that the pulses which enter the DGD 95 at different times exit the DGD at the same time. The phase modulator 93 may be one as has been described previously. The phase modulator 93 applies a phase shift to one or both polarisation modes. The phase shift applied to each polarisation mode may be different, due to the birefringence of the phase modulator.

The output of the phase modulator is connected to polarisation mixing device 97 such as has been described previously. The polarization mixing device can be omitted if the input fiber of the polarizing beam splitter 99 is rotated by 45 degrees with respect to the main axes of the beam splitter.

The output of the polarisation mixing device 97 is connected to the input of a polarizing beam splitter 99. One output of the polarizing beam splitter is connected to a detector 47, the second output is connected to a second detector, 46.

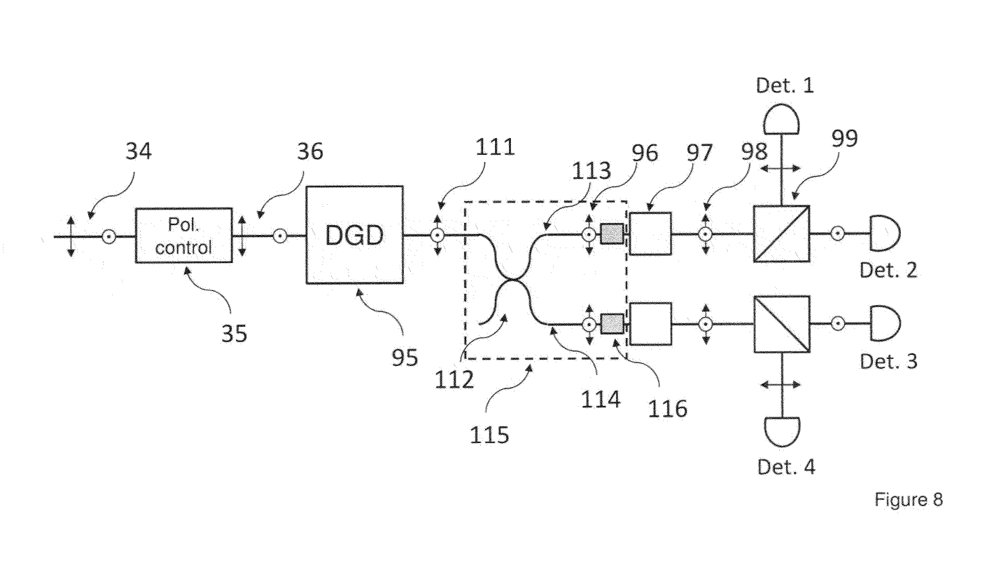

FIG. 8 shows a receiver where no phase modulator is used in the receiver. Instead, the basis is selected passively with a beam splitter 112 which randomly sends the incoming light either to the upper 113 or the lower arm 114 which have a chosen phase difference.

Both the upper arm 113 and the lower arm 114 introduce a fixed, but different phase difference between the two polarisation modes. This is achieved by fixed phase difference component 116. As for the system of FIG. 5, the fixed phase difference can be implemented by use of a heating element.

Polarization mixing elements 97 and beam splitters 99 in both arms are used to decode the key information as explained in FIG. 6. The figure displays a receiver with two arms for a protocol such as BB84. The receiver could also have more than two arms for different protocols.

The input fibre of the receiver connects to the polarisation controller 35 which has been described previously. The output of the polarisation controller 35 connects to the differential group delay line 95 as described with reference to FIG. 7. Thus light pulses which have travelled the different optical paths would emerge from the differential group delay line 95 at the same time, to within the signal laser coherence time, and with orthogonal polarisations. The output of the differential group delay line is connected to a beam splitter 112, the outputs of which connect to two arms 113 and 114.

The upper arm 113 is connected to a polarisation mixing device 97 such as has been described previously.

The lower arm 114 is connected to a polarisation mixing device 97 such as has been described previously.

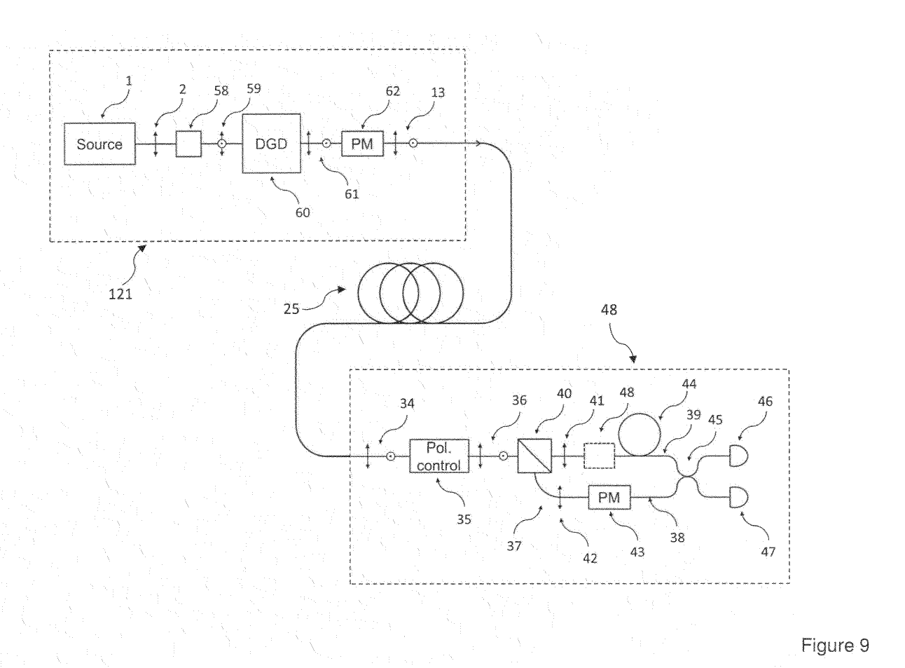

FIG. 9 is a schematic illustration of a Quantum Key Distribution system based on a Quantum Transmitter using a Differential Group Delay.

This figure illustrates a possible realization of a QKD system using the Quantum Transmitter shown in FIG. 2 121 and a Quantum Receiver based on an asymmetrical MZI 48. Quantum Transmitter 121 and Quantum Receiver 48 are connected by an optical transmission line 25.

The differential group delay line 60 is connected to a phase modulator 62. The light pulses emitted from the phase modulator 62 are transmitted to the receiver 145 via the optical transmission line 25. Thus, the Quantum Transmitter generates coherent double pulses with a chosen phase difference and orthogonal polarization 13 travelling down the transmission line. At the input of the Quantum Receiver the polarization of the double pulses is restored using a polarization controller and the pulses are then decoded using the asymmetrical MZI. The optical transmission line 25 may be a single mode optical fibre which allows propagation of the 2 modes without causing a significant change in path length between the 2 modes. However, it should be noted that all single mode fibres may have some birefringent characteristics. When travelling along fibre 25, it is possible that the polarisation will rotate. The polarisation controller corrects this rotation.

Using phase modulator 62 and phase modulator 43 a Quantum Key Distribution protocol such as BB84 can be realized.

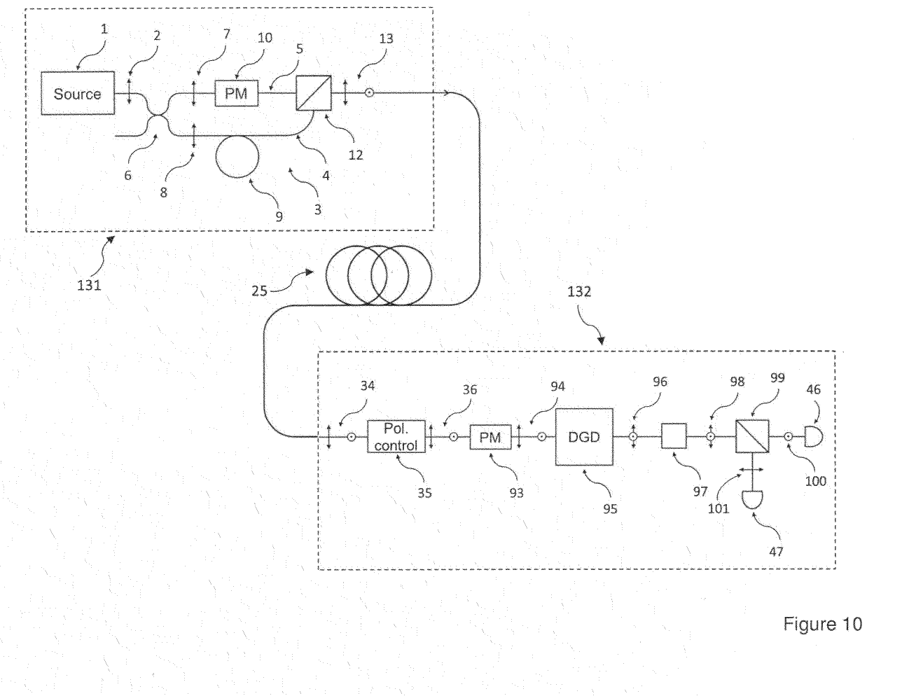

FIG. 10 is a schematic illustration of a Quantum Key Distribution system based on a Quantum Receiver using a Differential Group Delay in accordance with a further embodiment of the present invention.

This figure illustrates a possible realization of a QKD system using the Quantum Receiver shown in FIG. 6a 132 and a Quantum Transmitter based on an asymmetrical MZI 131. Quantum Transmitter 131 and Quantum Receiver 132 are connected by an optical transmission line 25. The Quantum Transmitter generates coherent double pulses with a chosen phase difference and orthogonal polarization 13 travelling down the transmission line. At the input of the Quantum Receiver the polarization of the double pulses is restored using a polarization controller and the pulses are then decoded using DGD line, polarization mixing device and the polarizing beam splitter. Using phase modulator 10 and phase modulator 93 a Quantum Key Distribution protocol such as BB84 can be realized.

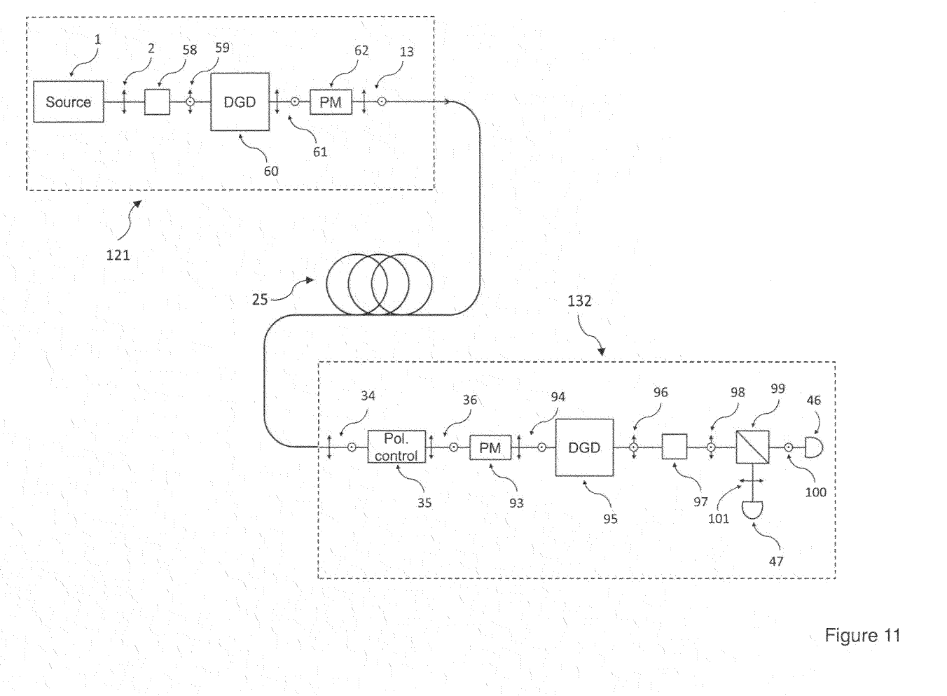

FIG. 11 is a schematic illustration of a Quantum Key Distribution system based on a Quantum Transmitter and Receiver using Differential Group Delay.

This figure illustrates a possible example of a QKD system using the Quantum Transmitter shown in FIG. 2 and the Quantum Receiver shown in FIG. 6a. Quantum Transmitter 121 and Quantum Receiver 132 are connected by an optical transmission line 25. The Quantum Transmitter generates coherent double pulses with a chosen phase difference and orthogonal polarization 13 travelling down the transmission line.

At the input of the Quantum Receiver the polarization of the double pulses is restored using a polarization controller and the pulses are then decoded using DGD line, polarization mixing device and the polarizing beam splitter. Using phase modulator 62 and phase modulator 93 a Quantum Key Distribution protocol such as BB84 can be realized.

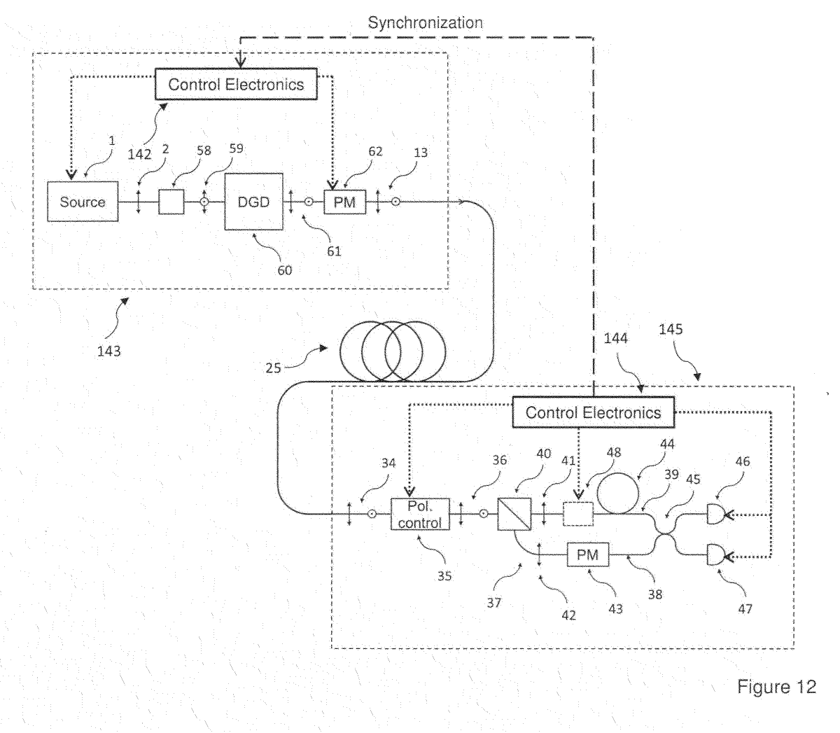

FIG. 12 is a schematic illustration of a Quantum Key Distribution system based on a Quantum Transmitter using Differential Group Delay with active stabilization on the receiver side.

Another example of a QKD system using the interferometer of the present invention might include the stabilization scheme shown in this figure. A synchronisation signal is sent from Quantum Receiver 145 to Quantum Transmitter 143. This synchronisation signal is used by the control electronics 142 to synchronise source 1 and phase modulator 62 with the receiver.

Another set of control electronics 144 on the receiver side is used for active stabilisation of polarization and phase difference of the coherent double pulses, as well as the gate delay of detectors one and two 46 and 47.

Elements used for this active stabilisation scheme are the polarisation controller 35 and a phase shifting device inside the interferometer. This can for example be an additional element 170 such as a fiber stretcher or can be implemented with the phase modulator 43. The stabilization scheme can also be realized by sending a synchronisation signal from the Quantum Transmitter to the Quantum Receiver instead of from the receiver to the transmitter.

The system of FIG. 12 is comprised of a transmitter 143 which comprises a light source 1 connected to a polarisation splitting device 58. The light source emits polarised light pulses. The polarisation splitting device divides light pulses into orthogonal polarisation modes with a desired intensity ratio. In other words, light pulses entering the polarisation splitting device will be split into a first polarisation mode with a first intensity and a second polarisation mode with a second intensity. The polarisation splitting device is connected to a differential group delay line 60, which is comprised of a birefringent material.

The differential group delay line 60 is connected to a phase modulator 62. The light pulses emitted from the phase modulator 62 are transmitted to the receiver 145 via the optical transmission line 25.

The quantum receiver comprises a polarisation controller 35 and an asymmetrical MZI 37. The asymmetrical MZI 37 comprises a polarising beam splitter 40, one output of which is connected to a long arm 39 and the other output of which is connected to a short arm 38. The long arm 39 comprises a loop of fiber 44 designed to cause an optical delay and a phase shifting device, for example, an additional element 170 such as a fiber stretcher. Alternatively, the phase shifting can be implemented with the phase modulator 43. The short arm 5 comprises a phase modulator 43. The other ends of the long arm 39 and the short arm 38 recombine on polarisation-maintaining beam splitter 45. Two single photon detectors 46, 47 are connected to the outputs of the polarisation maintaining beam splitter 45.

The quantum transmitter also comprises control electronics 142, which are connected to the light source 1 and the phase modulator 62. The receiver also comprises control electronics 144, which are connected to the polarisation controller 35, the phase shifting device 170 and the detectors 46 and 47.

The control electronics in the transmitter 142 and the control electronics in the receiver 144 are connected via a channel.

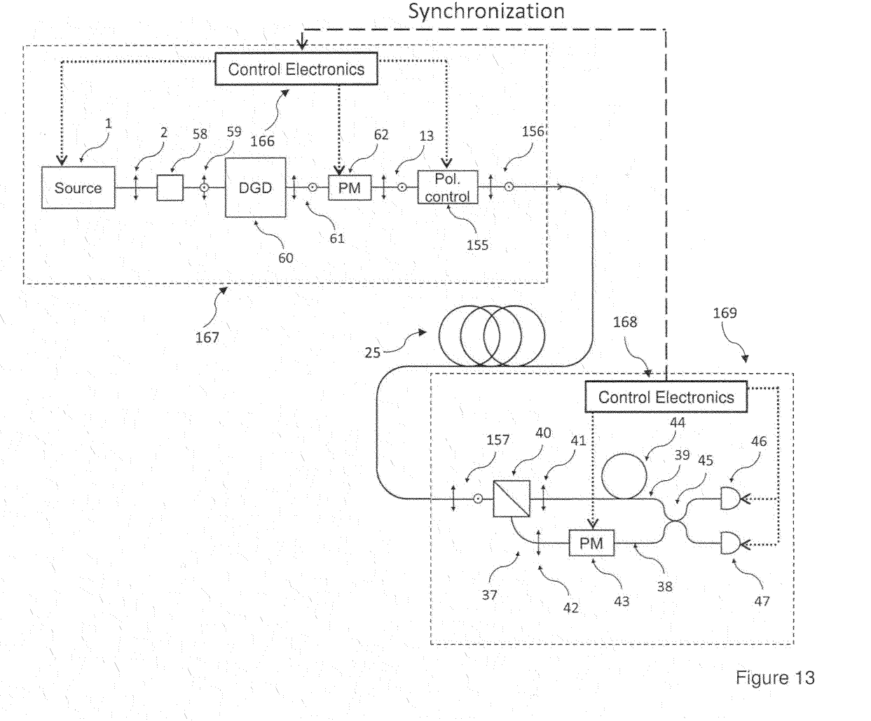

FIG. 13 is a schematic illustration of a Quantum Key Distribution system based on a Quantum Transmitter using Differential Group Delay with active stabilization on the transmitter side.

An active stabilization scheme can also be realized with a Quantum Transmitter such as that shown in FIG. 2. Again, the Quantum Receiver 169 sends a synchronization signal to the Quantum Transmitter 167. The receiver synchronizes its phase modulator 43 and detector gate delay with respect to this synchronisation signal by using the control electronics 168. The control electronics 166 on the transmitter side actively stabilise the phase difference and polarization of the coherent double pulses 156 sent to the receiver, as well as the exact timing of the source laser pulses with respect to the synchronization signal. The phase difference is controlled with the phase modulator 62 by changing its bias voltage. As explained previously, the two polarization modes experience a different phase shift inside the modulator which can be tuned by varying the bias voltage. Another option to control the relative phase difference of the double pulses is to adjust the modulation amplitude used to modulate the phase difference with the phase modulator. An additional polarization controller 155 pre-aligns the polarization of the double pulses 156 such that after transmission over the transmission line they are aligned 157 with respect to the axes of the polarizing beam splitter 40. The stabilization scheme can also be realized by sending a synchronisation signal from the Quantum Transmitter to the Quantum Receiver instead of from the receiver to the transmitter.

The system shown in FIG. 13 is similar to that of FIG. 12. However, in this system, the transmitter 167 also comprises a polarisation controller 155, which is connected to the output of the phase modulator 62. The receiver 169 therefore may not contain a polarisation controller 35 such as the receiver of the previous system. Further, instead of the phase shifting element 170 of the receiver of the previous system, the phase shifting can be implemented with the phase modulator 62.

The quantum transmitter comprises control electronics 166, which are connected to the light source 1, the polarisation controller 155 and the phase modulator 62. The receiver also comprises control electronics 168, which are connected to the phase modulator 43 and the detectors 46 and 47.

The control electronics in the transmitter 166 and the control electronics in the receiver 168 are connected via a channel.

While certain embodiments have been described, these embodiments have been presented by way of example only, and are not intended to limit the scope of the inventions. Indeed the novel methods and apparatus described herein may be embodied in a variety of other forms; furthermore, various omissions, substitutions and changes in the form of methods and apparatus described herein may be made without departing from the spirit of the inventions. The accompanying claims and their equivalents are intended to cover such forms of modifications as would fall within the scope and spirit of the inventions.

1. A modulation unit for a quantum communication system, wherein said modulation unit comprises an optical component configured to cause a delay between photons with different polarisation modes and a phase modulator, the optical component comprising a birefringent optical material, wherein the birefringent optical material supports the transmission of photons with a first polarisation mode and a second polarisation mode, wherein the optical path length for photons propagating with the first polarisation mode is different to the optical path length of photons propagating with the second polarisation mode, photons with the first polarisation mode having an orthogonal polarisation to those with the second polarisation mode, the phase modulator being configured to apply a further phase difference between photons with the first and second polarisation mode which pass through said modulation unit.

2. A modulation unit according to claim 1, wherein said first mode and said second mode propagate through said birefringent optical material in the same direction.

3. A modulation unit according to claim 1, wherein said birefringent optical material is selected from a birefringent optical fibre, a birefringent crystal and a birefringent photonic crystal.

4. A modulation unit according to claim 1, further comprising a directing unit configured to direct said first and second polarisation modes a plurality of times through said birefringent optical material.

5. A modulation unit according to claim 1, further comprising a polarisation splitting device configured to separate a light pulse into at least two polarisations.

6. A modulation unit according to claim 5, wherein said polarisation splitting device is selected from: two fibres spliced together with the slow axis of one fibre being rotated with respect to the other, a polarisation controller and a half wave plate.

7. A sending unit for a communication system, wherein said sending unit comprises a modulation unit according to claim 1, the phase modulator being configured to encode information on said photons.

8. A sending unit according to claim 7, wherein the phase modulator is positioned such that photons pass through said phase modulator after passing through said birefringent optical material, the unit further comprising a controller configured to control the modulation applied by said phase modulator.

9. A sending unit according to claim 7, wherein the phase modulator comprises a plurality of fixed phase elements each configured to apply a fixed phase difference, a switch configured to select each of the said components and a controller configured to operate said switch.

10. A sending unit according to claim 9, wherein each fixed phase element further comprises a light source.

11. A sending unit according to claim 7, further comprising a photon source, said photon source being configured to emit light pulses comprising 10 or fewer photons.

12. A receiving unit for a communication system, the receiving unit comprising a modulation unit according to claim 1, the unit being configured to decode information from weak light pulses using said phase modulator.

13. A receiving unit according to claim 12, wherein the phase modulator is positioned such that photons pass through said phase modulator before entering said birefringent optical material, the unit further comprising a controller configured to control the modulation applied by said phase modulator.

14. A receiving unit according to claim 12, wherein the phase modulator comprises a plurality of fixed phase difference elements each located in a different path, wherein each fixed phase difference element is configured to apply a fixed phase difference between the two polarisation modes such that the phase difference applied depends on the path taken by the photons.

15. A receiving unit according to claim 14, wherein each element comprises a detector.

16. A quantum communication system comprising a sending unit and a receiving unit, the sending unit comprising an interferometer and the receiving unit comprising an interferometer, wherein the interferometers comprise a first and second optical path with a difference in length between the first and second optical paths, and at least one of the interferometers comprises a birefringent optical material wherein the birefringent optical material supports the transmission of photons with a first polarisation mode and a second polarisation mode, wherein the optical path length for photons propagating with the first polarisation mode is different to the optical path length of photons propagating with the second polarisation mode.

17. A quantum communication system according to claim 16, wherein the delay caused by the interferometer in the sending unit between the first and second optical paths is reversed to the delay caused by the interferometer in the receiving unit such that a photon pulse which is separated by the first interferometer recombines when exiting the second interferometer.

18. A quantum communication system according to claim 16, wherein said first mode and said second mode propagate through said birefringent optical material in the same direction.

19. A quantum communication system according to claim 16, wherein both the interferometer of the sending unit and the receiving unit comprise a birefringent optical material wherein the birefringent optical material supports the transmission of photons with a first polarisation mode and a second polarisation mode, wherein the optical path length for photons propagating with the first polarisation mode is different to the optical path length of photons propagating with the second polarisation mode.

20. A method of quantum communication comprising:
sending encoded photons from a sending unit to a receiving unit wherein said photons are encoded using phase in the sending unit and decoded in the receiving unit and wherein the sending unit comprises an interferometer and a phase modulator to perform the encoding and the receiving unit comprises a phase modulator and an interferometer to perform the decoding, and wherein at least one of the interferometers comprises a birefringent optical material wherein the birefringent optical material supports the transmission of photons with a first polarisation mode and a second polarisation mode, wherein the optical path length for photons propagating with the first polarisation mode is different to the optical path length of photons propagating with the second polarisation mode.
